(19) United States
(12) Patent Application Publication
(10) Pub. No.: US 2022/0027424 A1
(43) Pub. Date: Jan. 27, 2022

(54) INFORMATION PROCESSING APPARATUS

(71) Applicant: FUJIFILM BUSINESS INNOVATION CORP., Tokyo (JP)

(72) Inventors: Yasuto ISHIBASHI, Yokohama-shi (JP); Chizuko SENTO, Yokohama-shi (JP)

(73) Assignee: FUJIFILM BUSINESS INNOVATION CORP., Tokyo (JP)

(21) Appl. No.: 17/152,191

(22) Filed: Jan. 19, 2021

(51) Int. Cl. G06F 16/9535; G06F 16/9035; G06F 16/908; G06F 16/9536

(52) U.S. Cl. CPC G06F 16/9535; G06F 16/9536; G06F 16/908; G06F 16/9035

(57) ABSTRACT

An information processing apparatus includes a processor configured to acquire at minimum a viewing history associated with one or more items selected from multiple items for introducing a first user and determine an evaluation value for the first user in accordance with the acquired viewing history.

### CROSS-REFERENCE TO RELATED APPLICATIONS

This application is based on and claims priority under 35 USC 119 from Japanese Patent Application No. 2020-125392 filed Jul. 22, 2020.

### BACKGROUND

### (i) Technical Field

The present disclosure relates to an information processing apparatus.

### (ii) Related Art

Japanese Unexamined Patent Application Publication No. 2018-85037 discloses a technology that uses viewing-operation information, which is the information regarding a viewing operation performed by a user on displayed content, to identify a region of interest for the user in the displayed content and delivers related content that is related to the content in the identified region of interest.

### SUMMARY

In a matchmaking service to search for people who may be interested in each other, for example, sending to a person the information, such as “Like” and “Footprint”, indicating interest in the person is supposed to convey the interest in the person. However, since such information can be sent to a person who attracts no attention, a recipient of the information is not able to decide with certainty whether the interest in the recipient is genuine. Thus, aspects of non-limiting embodiments of the present disclosure relate to facilitating a decision about whether interest is genuine in the case where information indicating interest in a person is received.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to acquire at minimum a viewing history associated with one or more items selected from a plurality of items for introducing a first user and determine an evaluation value for the first user in accordance with the acquired viewing history.

### BRIEF DESCRIPTION OF THE DRAWINGS

An exemplary embodiment of the present disclosure will be described in detail based on the following figures, wherein:

FIG. 1 is a diagram depicting an entire configuration of a matchmaking support system according to the exemplary embodiment;

FIG. 2 is a diagram depicting a hardware configuration of an information processing apparatus;

FIG. 3 is a diagram depicting a hardware configuration of a user terminal;

FIG. 4 is a diagram depicting a functional configuration realized in the matchmaking support system;

FIG. 5 is an illustration depicting an example of a presented menu screen;

FIG. 6 is an illustration depicting an example of a presented screen for entering introduction information;

FIG. 7 is an illustration depicting an example of a presented screen for viewing introduction information;

FIG. 8 is an illustration depicting an example of a stored viewing history;

FIG. 9 is an illustration depicting an example of a presented screen for selecting emphasized items;

FIG. 10 is an illustration depicting an example of stored emphasized items;

FIG. 11 is an illustration depicting an example of a table of levels of interest;

FIG. 12 is an illustration depicting an example of stored evaluation results;

FIG. 13 is an illustration depicting an example of levels of interest that are presented;

FIG. 14 is a diagram depicting an example of an operation procedure in an evaluation process;

FIG. 15 is an illustration depicting an example of a screen for viewing introduction information according to a modification;

FIG. 16 is an illustration depicting an example of a stored viewing history;

FIG. 17 is a diagram depicting a functional configuration realized in the modification;

FIG. 18 is an illustration depicting an example of a presented query screen;

FIG. 19 is an illustration depicting an example of a presented screen for viewing introduction information; and

FIG. 20 is an illustration depicting another example of a presented screen for viewing introduction information.

### DETAILED DESCRIPTION

### 1 Exemplary Embodiment

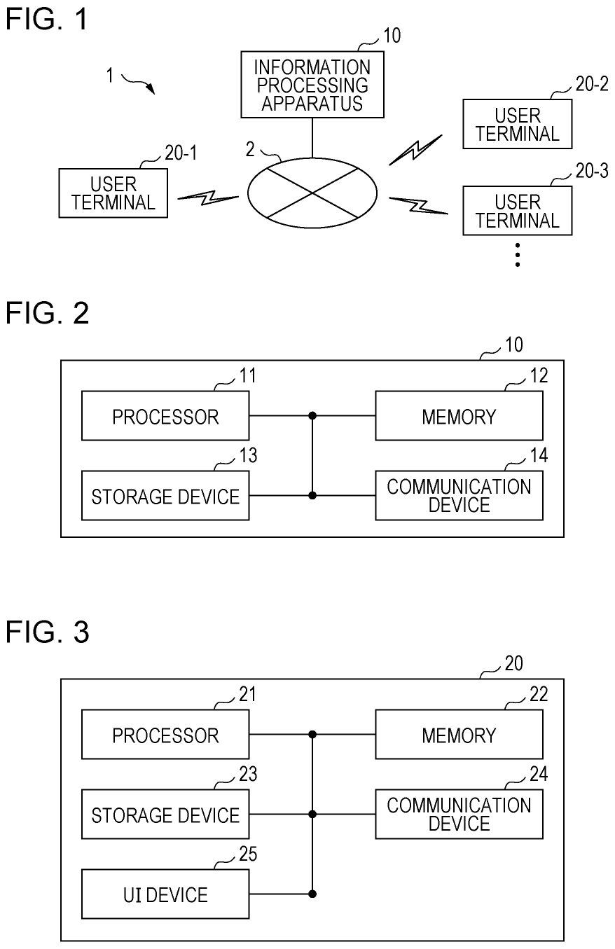

FIG. 1 depicts an entire configuration of a matchmaking support system 1 according to the exemplary embodiment. The matchmaking support system 1 supports matchmaking by which to find a right person for a client. Matchmaking is employed, for example, to find a partner or to find a potential employee.

The matchmaking support system 1 includes a communication line 2, an information processing apparatus 10, and a plurality of user terminals 20-1, 20-2, . . . (referred to as a “user terminal 20” when individual terminals are not distinguished). In the following description, for convenience in description, a user of the user terminal 20-1 is referred to as a “first user”, and a user of the user terminal 20 other than the user terminal 20-1 is referred to as a “second user”. A description will be given of a case where the first user searches for a right person for the first user among a plurality of second users.

The communication line 2 is a communication system including a mobile communication network, the Internet, and other networks and relays data exchanges between the information processing apparatus 10 or the user terminal 20 and communicating equipment (such as apparatuses, terminals, and systems). The information processing apparatus 10 connects to the communication line 2 via wireline communication, and the user terminal 20 connects to the communication line 2 via wireless communication. The method of communication between each apparatus and the communication line 2 is not limited to the one in the example in FIG. 1, and each apparatus and the communication line 2 may be connected to each other via wireline communication or wireless communication.

The information processing apparatus 10 performs a process by which to support matchmaking. The information processing apparatus 10 performs, for example, a process by which to store introduction information for introducing a user and a process by which to deliver to the user terminal 20 an introduction screen presenting introduction information. The user terminal 20 is used by a user of the matchmaking support system 1. The user terminal 20 performs, for example, a process by which to accept an entry of introduction information and a process by which to present a delivered introduction screen.

FIG. 2 depicts a hardware configuration of the information processing apparatus 10. The information processing apparatus 10 is a computer that includes a processor 11, a memory 12, a storage device 13, and a communication device 14. The processor 11 includes, for example, a computing device such as a central processing unit (CPU), a register, and a peripheral circuit. The memory 12 is a recording medium readable by the processor 11 and includes, for example, a random-access memory (RAM) and a read-only memory (ROM).

The storage device 13 is a recording medium readable by the processor 11 and includes, for example, a hard disk drive or a flash memory. The processor 11 uses the RAM as a work area and executes programs stored in the ROM and in the storage device 13, thereby controlling operation of each piece of hardware. The communication device 14 includes, for example, an antenna and a communication circuit and is a communication unit that performs communication via the communication line 2.

FIG. 3 depicts a hardware configuration of the user terminal 20. The user terminal 20 is a computer that includes a processor 21, a memory 22, a storage device 23, a communication device 24, and a user interface (UI) device 25. The components from the processor 21 to the communication device 24 include pieces of hardware similar to the components from the processor 11 to the communication device 14 depicted in FIG. 2.

The UI device 25 is an interface provided to a user who uses the user terminal 20. The UI device 25, which includes, for example, a touch screen in which a display as a presentation unit and a touch panel disposed on the surface of the display are included, presents an image and accepts an operation by the user at the same time. The UI device 25 also includes operators, such as a keyboard, in addition to the touch screen and accepts operation on the operators.

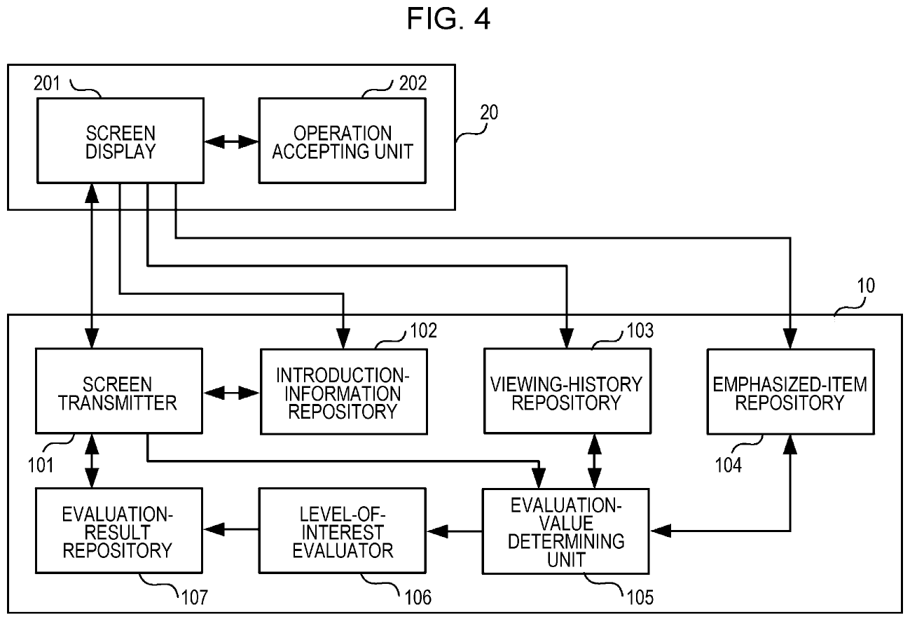

In the matchmaking support system 1, the processors of the apparatuses described above execute programs and control each unit, thereby realizing the functions described below. An operation performed by each function is also represented as an operation performed by the processor of an apparatus that realizes the function. FIG. 4 depicts a functional configuration realized in the matchmaking support system 1. The information processing apparatus 10 includes a screen transmitter 101, an introduction-information repository 102, a viewing-history repository 103, an emphasized-item repository 104, an evaluation-value determining unit 105, a level-of-interest evaluator 106, and an evaluation-result repository 107. The user terminal 20 includes a screen display 201 and an operation accepting unit 202.

The screen transmitter 101 of the information processing apparatus 10 creates a screen regarding matchmaking (hereinafter, referred to as a “matchmaking screen”) and transmits image data representing the created screen to the user terminal 20. The screen display 201 of the user terminal 20 presents the matchmaking screen represented by the received image data. The matchmaking screen has, for example, a menu screen in which to perform various operations.

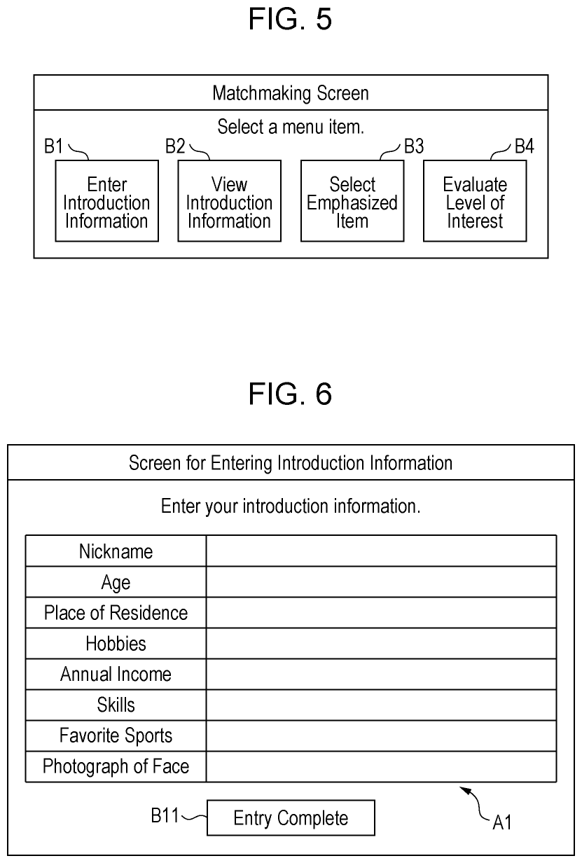

FIG. 5 depicts an example of a presented menu screen. In the example in FIG. 5, the screen display 201 presents the character string “Select a menu item.” and an image for operation, and the image for operation includes an entry button B1 for introduction information, a viewing button B2 for introduction information, a selection button B3 for an emphasized item, and an evaluation button B4 for the level of interest. The operation accepting unit 202 accepts an operation on the image for operation, which is presented.

The screen display 201 presents a screen in accordance with an operation accepted by the operation accepting unit 202. For example, in response to the acceptance of an operation on the entry button B1, the screen display 201 sends to the information processing apparatus 10 a request for a screen corresponding to the entry button B1. The screen transmitter 101 of the information processing apparatus 10 returns image data representing the requested screen, that is, a screen for entering introduction information, the screen corresponding to the entry button B1. The screen display 201 receives the returned image data, thereby acquiring the screen for entering introduction information represented by the image data, and presents the acquired screen for entering introduction information.

FIG. 6 depicts an example of a presented screen for entering introduction information. In the example in FIG. 6, the screen display 201 presents the character string “Enter your introduction information.”, an entry section A1, and an entry-complete button B11, and the entry section A1 is used to enter the nickname, the age, the place of residence, hobbies, the annual income, skills, favorite sports, and a photograph of the face. In response to an operation of pressing the entry-complete button B11 after introduction information is entered in the entry section A1, the screen display 201 transmits the introduction information entered in the entry section A1 to the information processing apparatus 10. The introduction-information repository 102 of the information processing apparatus 10 stores the received introduction information regarding the user.

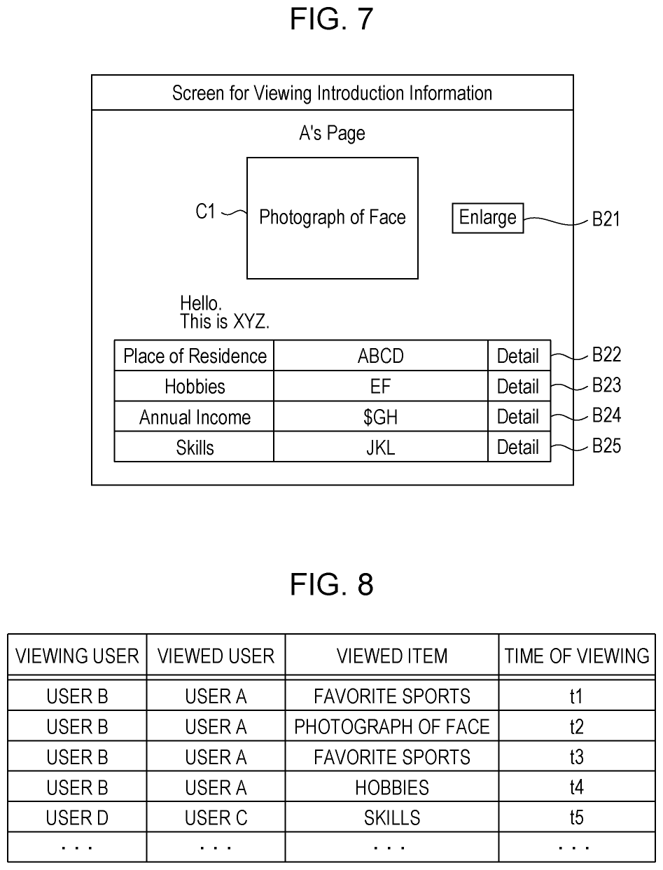

In response to the acceptance of an operation on the viewing button B2, the screen display 201 of the user terminal 20 acquires a screen corresponding to the viewing button B2 from the information processing apparatus 10 and presents the screen according to a procedure similar to the above procedure. FIG. 7 depicts an example of a presented screen for viewing introduction information. In the example in FIG. 7, the screen display 201 presents the character strings “A's Page” and “Hello. This is XYZ.”, a photograph of the face C1, and an enlarge button B21.

In response to a viewing user who views the screen for viewing introduction information pressing the enlarge button B21, the screen display 201 presents an enlarged image of the photograph of the face C1. The screen display 201 also presents the items including the place of residence, hobbies, the annual income, and skills together with the corresponding detail buttons B22, B23, B24, and B25. It is assumed that the presentation of each item represents only part of the entered introduction information. The age and other items described above can also be presented by scrolling the screen.

In response to the viewing user pressing each detail button, the screen display 201 presents the detail of introduction information regarding the corresponding item. The screen display 201 transmits to the information processing apparatus 10 the history and the time of presenting the enlarged photograph and each detail as a viewing history of the viewing user. The viewing-history repository 103 of the information processing apparatus 10 stores the received viewing history in association with the viewing user and the viewed user.

FIG. 8 depicts an example of a stored viewing history. In the example in FIG. 8, the viewing-history repository 103 stores viewing users, viewed users, viewed items, and time of viewing in association with each other. The stored viewing history indicates that, for example, a user B viewed the item “Favorite sports” of a user A at the time t1 and t3, similarly the user B viewed the item “Photograph of Face” of the user A at the time t2, and similarly the user B viewed the item “Hobbies” of the user A at the time t4. The stored viewing history also indicates that a user D viewed the item “Skills” of a user C at the time t5.

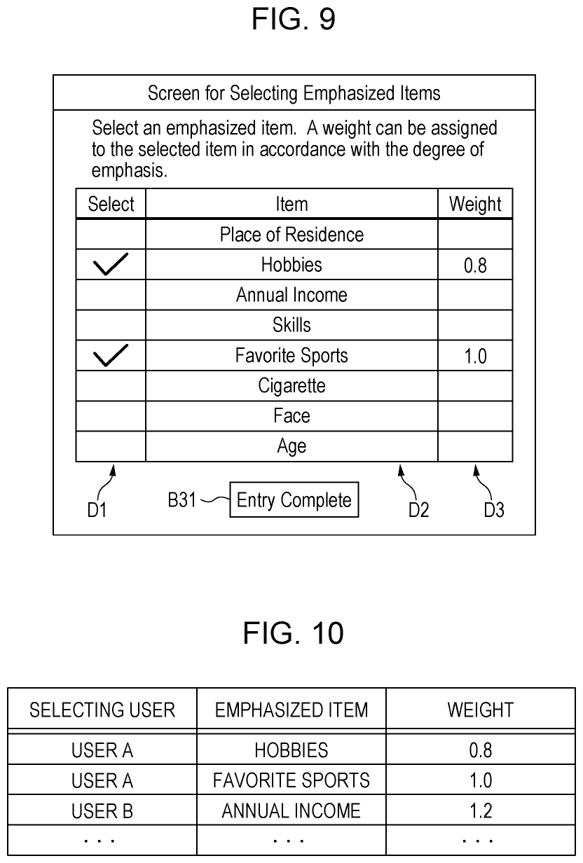

In response to the acceptance of an operation on the selection button B3 for an emphasized item, the screen display 201 of the user terminal 20 acquires a screen corresponding to the selection button B3 for an emphasized item from the information processing apparatus 10 and presents the screen according to a procedure similar to the above procedure. FIG. 9 depicts an example of a presented screen for selecting emphasized items. In the example in FIG. 9, the screen display 201 presents the character string “Select an emphasized item. A weight can be assigned to the selected item in accordance with the degree of emphasis.”, a check column D1 to indicate selected items, an item list D2, a weight entry column D3 for weighting the items, and an entry-complete button B31.

The screen display 201 presents a check mark in a check box that the viewing user has operated (in the example in FIG. 9, the check boxes corresponding to the items “Hobbies” and “Favorite Sports”). A check mark indicates that the item is selected. The screen display 201 also presents a number entered in a weight entry box, in which the viewing user has entered the number (in the example in FIG. 9, “0.8” for the item “Hobbies” and “1.0” for the item “Favorite Sports”). An entered weight value determines the degree of emphasis assigned to each of the plurality of items. As the weight value of an item increases, the degree of emphasis assigned to the item increases.

In response to an operation of pressing the entry-complete button B31 by the user, the screen display 201 transmits the data indicating one or more checked items and the corresponding weights to the information processing apparatus 10 as the emphasized-item data indicating the one or more emphasized items selected by the user. The emphasized-item repository 104 of the information processing apparatus 10 stores the one or more emphasized items and the corresponding weights that are indicated by the received emphasized-item data in association with the selecting user who has selected those items.

FIG. 10 depicts an example of stored emphasized items. In the example in FIG. 10, the emphasized-item repository 104 stores selecting users, emphasized items, and weights that are associated with each other. The stored emphasized items indicate that, for example, the user A places emphasis on the items “Hobbies” and “Favorite sports” and greater emphasis on the item “Favorite Sports”, which has a higher weight than the other item.

In response to the acceptance of an operation on the evaluation button B4 for the level of interest, the screen display 201 of the user terminal 20 sends to the information processing apparatus 10 a request for a screen corresponding to the evaluation button B4 for the level of interest in the user who uses the user terminal 20. A user who requests evaluation of the level of interest in this way is referred to as an “evaluating user” in the following description. The screen transmitter 101 of the information processing apparatus 10 provides the evaluation-value determining unit 105 with instructions to determine an evaluation value for the evaluating user to create a requested screen, that is, a screen indicating the level of interest in the evaluating user.

The evaluation value indicates a degree of interest in the evaluating user, and the degree of interest in the evaluating user increases as the evaluation value increases in the present exemplary embodiment. In response to receiving the above instructions, the evaluation-value determining unit 105 determines an evaluation value for the evaluating user. The evaluation-value determining unit 105 determines an evaluation value in accordance with the viewing history stored in the viewing-history repository 103 and the emphasized items stored in the emphasized-item repository 104.

The viewing-history repository 103 stores the viewing history in association with the viewing users and the viewed users. The emphasized-item repository 104 stores the emphasized items selected by selecting users and the corresponding weights. First, the evaluation-value determining unit 105 retrieves from the emphasized-item repository 104 the emphasized items and the corresponding weights that are stored for a selecting user who is the same as the evaluating user. Next, the evaluation-value determining unit 105 retrieves from the viewing-history repository 103 viewing-history items associated with the retrieved emphasized items out of the viewing-history items having the evaluating user as the viewed user.

In this way, if one or more items are selected as the emphasized items from a plurality of items for introducing the evaluating user, the evaluation-value determining unit 105 acquires at minimum a viewing history associated with the one or more items selected as the emphasized items from the plurality of items. Then, the evaluation-value determining unit 105 determines an evaluation value for the evaluating user in accordance with the viewing history that has been acquired. The evaluation-value determining unit 105 designates as an evaluation value, for example, a ratio that reflects weights of emphasized items viewed by a viewing user.

For example, it is assumed that the viewing history depicted in FIG. 8 and the emphasized items depicted in FIG. 10 are stored and the user A performs an operation to request evaluation of a level of interest as the evaluating user. In such a case, since the user B, who is a viewing user, has a history of viewing both the items “Favorite Sports” (weight: 1.0) and “Hobbies” (weight: 0.8), which are the emphasized items selected by the user A, who is the evaluating user, the evaluation-value determining unit 105 calculates the evaluation value of the user B for the user A as (1.0+0.8)/(1.0+0.8)=100%.

If only the item “Favorite Sports” is included in the viewing history, the evaluation-value determining unit 105 calculates the evaluation value as 1.0/(1.0+0.8)=55.6%. If only the item “Hobbies” is included in the viewing history, the evaluation-value determining unit 105 calculates the evaluation value as 0.8/(1.0+0.8)=44.4%. As described above, the evaluation-value determining unit 105 determines an evaluation value in accordance with weight values, or the degrees of emphasis, which have been determined.

The evaluation-value determining unit 105 also determines evaluation values of other users for the user A. The evaluation-value determining unit 105 calculates the evaluation value of a user as “0” if the user has no viewing history for the user A. The evaluation-value determining unit 105 provides the level-of-interest evaluator 106 with the calculated evaluation values and identifiers (such as user identification (ID)) that identify the evaluating user and viewing users.

The level-of-interest evaluator 106 evaluates degrees of interest in the evaluating user from viewing users in accordance with provided evaluation values. The evaluating user is an example of a “first user” in the present disclosure, and a viewing user is an example of a “second user” in the present disclosure. In the present exemplary embodiment, if an evaluation value is provided as described above, that is, the evaluating user selects one or more items as emphasized items and the viewing history of a viewing user is acquired, the level-of-interest evaluator 106 evaluates the degree of interest in the evaluating user from the viewing user.

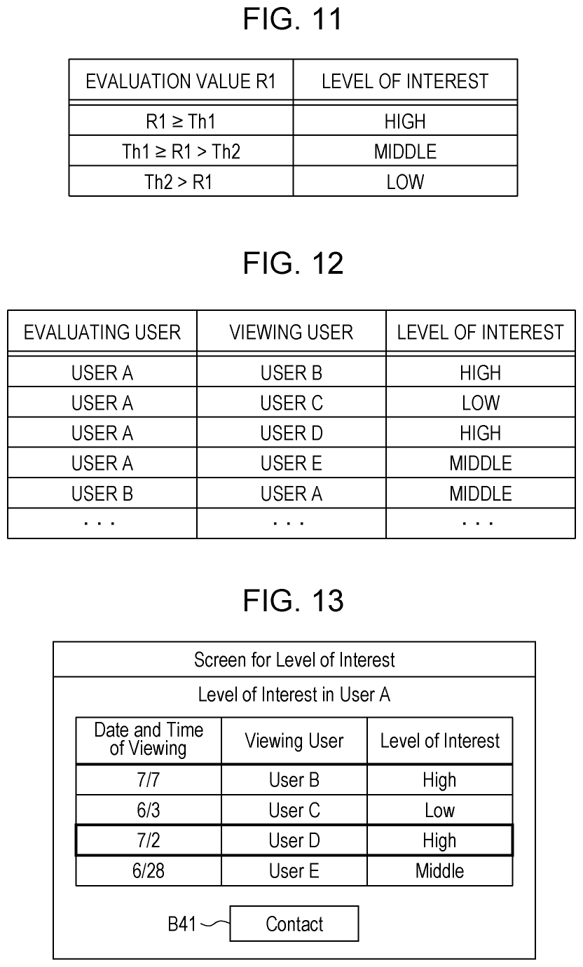

The level-of-interest evaluator 106 evaluates a level of interest, for example, by using a table of levels of interest that associates an evaluation value with a level of interest. FIG. 11 depicts an example of a table of levels of interest. In the example in FIG. 11, the ranges of an evaluation value R1“R1≥Th1”, “Th1>R1≥Th2”, and “Th2>R1” are associated with the levels of interest “HIGH”, “MIDDLE”, and “LOW”, respectively.

The level-of-interest evaluator 106 designates the level of interest associated with the range including the evaluation value provided by the evaluation-value determining unit 105 as the level of interest in the evaluating user from the viewing user indicated by the similarly provided identifier. The level-of-interest evaluator 106 determines, for example, that the level of interest is “HIGH” if the provided evaluation value is “R1 Th1” and the level of interest is “LOW” if the provided evaluation value is “Th2>R1”.

As described above, if a degree of emphasis is assigned to each of a plurality of items, the level-of-interest evaluator 106 evaluates a degree of interest in accordance with the degrees of emphasis assigned to viewed items. The level-of-interest evaluator 106 evaluates a level of interest as described above and provides the evaluation-result repository 107 with the evaluation result. The evaluation-result repository 107 stores the provided evaluation result. FIG. 12 depicts an example of the stored evaluation results. In the example in FIG. 12, the evaluation-result repository 107 stores evaluation results that associate the evaluating user “user A” with the viewing user “user B” or “user D” and the level of interest “HIGH”.

The evaluation-result repository 107 also stores an evaluation result associated with the viewing user “user E” and having the level of interest “MIDDLE” and an evaluation result associated with the viewing user “user C” and having the level of interest “LOW”. The screen transmitter 101 designates as the evaluating user a user who has sent a request for evaluation of a level of interest and transmits to the user terminal 20 the level-of-interest screen data that indicates the level of interest from each viewing user. The screen display 201 of the user terminal 20 presents one or more levels of interest indicated by the received level-of-interest screen data.

FIG. 13 depicts an example of levels of interest that are presented. In the example in FIG. 13, the screen display 201 presents the character string “Level of Interest in User A”, a table in which date and time of viewing, a viewing user, and a level of interest are associated with each other, and a contact button B41. The user A, who is the evaluating user, refers to the presented levels of interest and selects a user with whom to get in contact by using an application such as a social networking service (SNS).

In the example in FIG. 13, the user D, to whom the level of interest “High” is assigned, is selected. In this situation, in response to an operation of pressing the contact button B41, the screen display 201 presents, for example, a screen used to get in contact with the user D out of the screens provided by the corresponding application. In this way, less time and effort are required to get in contact with a person who has a high level of interest in the evaluating user than in the case where an operation of opening an application screen is separately required.

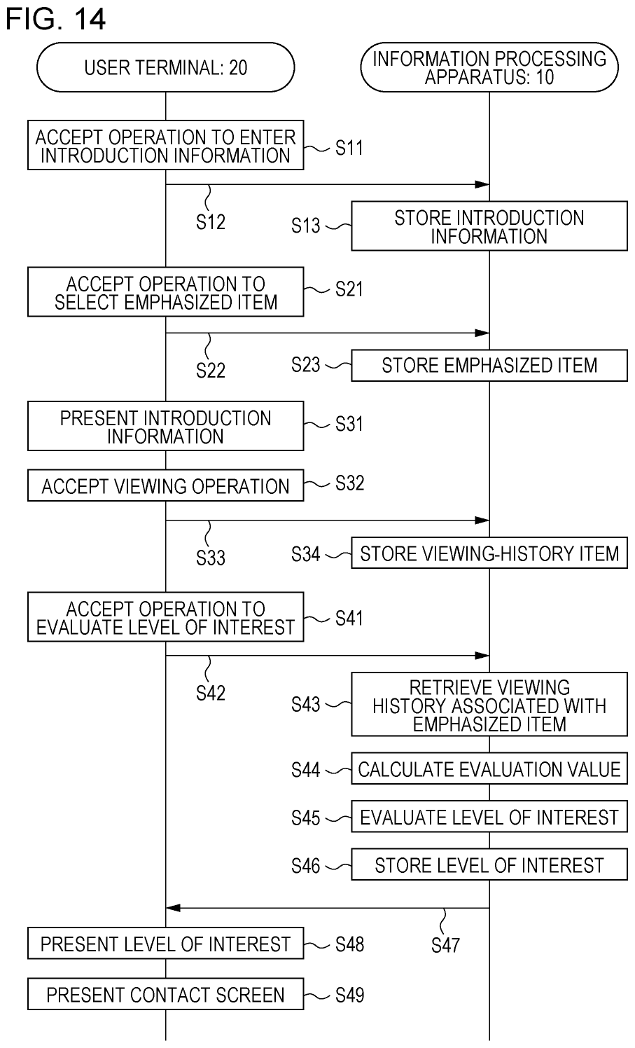

Each apparatus included in the matchmaking support system 1 is configured as described above and thereby performs the evaluation process in which levels of interest in the evaluating user from viewing users are evaluated. FIG. 14 depicts an example of an operation procedure in the evaluation process. First, the user terminal 20 (operation accepting unit 202) accepts an operation to enter introduction information (step S11). Next, the user terminal 20 (screen display 201) transmits to the information processing apparatus 10 the introduction information that has been entered (step S12).

Subsequently, the information processing apparatus 10 (introduction-information repository 102) stores the received introduction information regarding the user (step S13). Next, the user terminal 20 (operation accepting unit 202) accepts an operation to select one or more emphasized items (step S21). Then, the user terminal 20 (screen display 201) transmits to the information processing apparatus 10 the one or more emphasized items, which have been selected (step S22). The information processing apparatus 10 (emphasized-item repository 104) stores the one or more emphasized items, which have been received, in association with the user who has selected the one or more emphasized items (step S23).

Next, the user terminal 20 (screen display 201) presents the introduction information stored in the information processing apparatus 10 (step S31). Subsequently, the user terminal 20 (operation accepting unit 202) accepts from a viewing user a viewing operation to view an item that attracts attention (step S32). Next, the user terminal 20 (the screen display 201) transmits to the information processing apparatus 10 a viewing-history item that corresponds to the accepted viewing operation (step S33).

The information processing apparatus 10 (viewing-history repository 103) stores the received viewing-history item (step S34). Next, the user terminal 20 (operation accepting unit 202) accepts an operation by an evaluating user to evaluate levels of interest in the evaluating user (step S41). Subsequently, the user terminal 20 (screen display 201) transmits to the information processing apparatus 10 the request data to request a screen regarding levels of interest (step S42).

The information processing apparatus 10 (evaluation-v alue determining unit 105) retrieves the viewing history associated with the one or more emphasized items selected by the evaluating user indicated by the received request data (step S43). Next, the information processing apparatus 10 (evaluation-value determining unit 105) calculates an evaluation value in accordance with the viewing history that has been retrieved (step S44). Subsequently, the information processing apparatus 10 (level-of-interest evaluator 106) evaluates the level of interest in the evaluating user from a viewing user in accordance with the calculated evaluation value (step S45). Next, the information processing apparatus 10 (evaluation-result repository 107) stores the evaluated level of interest (step S46).

Subsequently, the information processing apparatus 10 (screen transmitter 101) designates as the evaluating user the user who has sent the request for evaluation of levels of interest and transmits to the user terminal 20 the level-of-interest screen data that indicates the level of interest from each viewing user (step S47). The user terminal 20 (screen display 201) presents one or more levels of interest indicated by the received level-of-interest screen data (step S48). Then, the user terminal 20 (screen display 201) presents a screen for getting in contact with a viewing user selected from the presented viewing users (step S49).

In the present exemplary embodiment, as described above, the viewing history associated with the one or more items selected from the plurality of items for introducing the evaluating user is acquired, and the evaluation values for the evaluating user are determined in accordance with the acquired viewing history. Although a viewing history can be regarded as information indicating interest in a person, some people may haphazardly view screens that attract no attention, and viewing-history items that do not lead to interest in the person are sometimes mixed into the viewing history as noise.

In the present exemplary embodiment, viewing-history items are narrowed down as described above, thereby reducing the noise described above and facilitating a decision about whether the interest in the person is genuine compared with a case of using all the viewing-history items. In addition, in the present exemplary embodiment, since the evaluating user selects emphasized items, it is possible to find a person who is attracted by the items in which the evaluating user wants the person to be interested. Further, in the present exemplary embodiment, since a degree of emphasis is assigned to an individual item, it is possible to find a person who is attracted by the items in which the evaluating user wants the person to be more interested compared with a case of treating all the items equally.

### 2 Modifications

The exemplary embodiment described above is only an example in which to embody the present disclosure and may be modified as described below. In addition, the exemplary embodiment and modifications may be combined with each other as necessary and executed.

### 2-1 Method of Determining Evaluation Value

The evaluation-value determining unit 105 may determine an evaluation value by using a method different from the one in the exemplary embodiment. For example, the evaluation-value determining unit 105 may determine an evaluation value without assigning weights. Further, the evaluation-value determining unit 105 may set an evaluation value equal to 1.0 if at least one emphasized item is viewed and equal to 0.0 if no emphasized item is viewed.

The evaluation-value determining unit 105 may set an evaluation value equal to the average of an evaluation value determined as above based on whether at least one emphasized item is viewed and an evaluation value described in the exemplary embodiment. Further, the evaluation-value determining unit 105 may set an evaluation value equal to the sum of the numbers of views each multiplied by a weight. For example, in the example in FIG. 8, since the user B views the item “Favorite Sports” of the user A twice and the item “Hobbies” once, the evaluation-value determining unit 105 calculates an evaluation value as 2×1.0+1×0.8=2.8.

Further, if an operation of transmitting the information indicating interest in a person with regard to a viewed item (referred to as a “transmitting operation” below) is accepted, the evaluation-value determining unit 105 may determine an evaluation value by using the viewing history preceding the transmitting operation being performed. Examples of the information indicating interest in a person include “Like”, “Follow”, and “Subscribe”, which are frequently used in an SNS and the like. Examples of the transmitting operation include operations of pressing a “Like button”, a “Follow button”, and a “Subscribe button”.

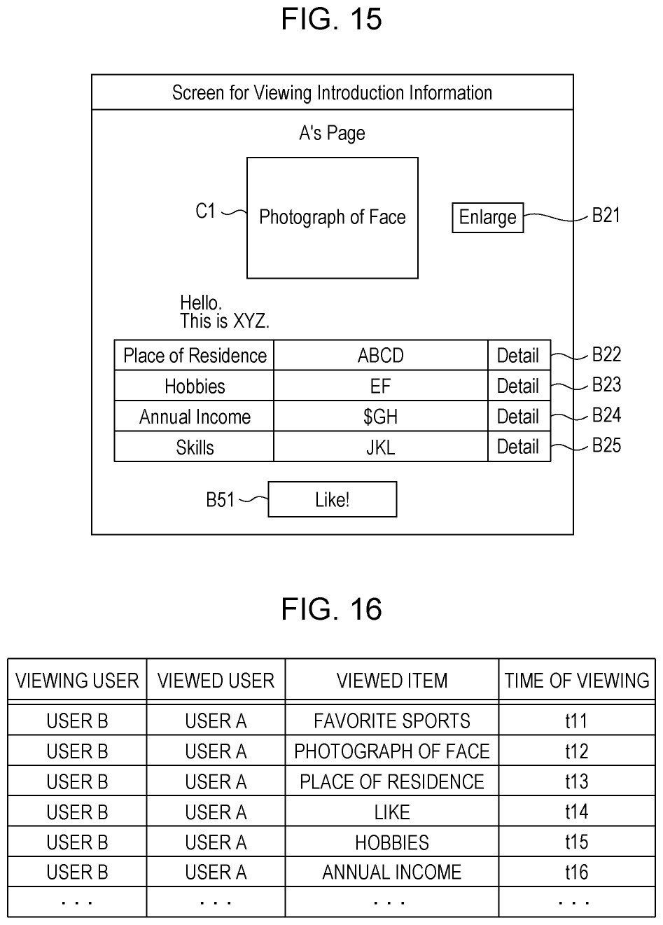

FIG. 15 depicts an example of a screen for viewing introduction information according to the present modification. In the example in FIG. 15, the screen display 201 presents a Like button B51 in addition to each image depicted in FIG. 7. The screen display 201 transmits to the information processing apparatus 10 the history and the time of performing an operation of pressing the Like button B51 as an operating history item in addition to the history and the time of presenting the enlarged photograph and the detail. The viewing-history repository 103 stores the received viewing-history items.

FIG. 16 depicts an example of stored viewing-history items. In the example in FIG. 16, the viewing-history repository 103 stores a viewing user, who is the user B, a viewed user, who is the user A, and a viewing-history item, which are associated with each other. The viewing-history items indicate that the item “Favorite Sports” was viewed at the time t11, the item “Photograph of Face” was viewed at the time t12, the item “Place of Residence” was viewed at the time t13, the item “Hobbies” was viewed at the time t15, and the item “Annual Income” was viewed at the time t16. In addition, an operation of pressing the “Like” button was performed at the time t14.

In the example in FIG. 16, since the operation of pressing the Like button B51, which is a transmitting operation, was performed at the time t14, the evaluation-value determining unit 105 determines an evaluation value in accordance with the viewing-history items associated with the items “Favorite Sports”, “Photograph of Face”, and “Place of Residence”, which were viewed before the time t14. In this situation, the evaluation-value determining unit 105 does not use the viewing-history items associated with the items “Hobbies” and “Annual Income”, which were viewed after the time t14, to determine the evaluation value.

Since the evaluation value is determined as described above, if a transmitting operation is accepted, the level-of-interest evaluator 106 evaluates a degree of interest by using a viewing history preceding the point that the transmitting operation is performed. A viewing user often starts by viewing an item that interests the viewing user, but it is uncertain whether the viewing user is interested in the content of the item viewed by the viewing user. For example, if a viewing user views the item “Favorite Sports” first, it may happen that the viewing user becomes interested in the person if the content of the item concerns “Soccer” but is uninterested in the person if the content of the item concerns “Table Tennis”.

However, performing the transmitting operation clearly indicates that the viewing user has become interested in the person because of the introduction information viewed before the transmitting operation. Thus, the viewing history preceding the transmitting operation being performed indicates the degree of interest from the viewing user more clearly than the viewing history following the transmitting operation. In the present modification, the degree of interest from the viewing user is evaluated more accurately than in the case where the degree of interest is evaluated by using the viewing history following the transmitting operation.

### 2-2 Selection of Emphasized Items

In the exemplary embodiment, the evaluating user selects emphasized items, but a viewing user may select one or more items as emphasized items. In this case, the evaluation-value determining unit 105 acquires a viewing history associated with the emphasized items selected by the viewing user and determines an evaluation value for the evaluating user in accordance with the viewing history that has been acquired.

Since the evaluation value is determined as described above, the level-of-interest evaluator 106 evaluates the degree of interest in the evaluating user from the viewing user by using the viewing history associated with the emphasized items selected by the viewing user. Since the viewing user selects the emphasized items in the present modification, the viewing user views the selected emphasized items and thereby provides the person (or the evaluating user) with the impression that the viewing user is interested in the person.

In the present modification, weighting may be performed as in the exemplary embodiment. If a degree of emphasis is assigned to each of a plurality of items in this way, the level-of-interest evaluator 106 evaluates a degree of interest in accordance with the degrees of emphasis assigned to the viewed items. In this way, since a degree of emphasis is assigned to an individual item, it is possible to provide the person (or the evaluating user) with the impression of items in which the viewing user is more interested compared with the case of treating all the items equally.

The transmitting operation described above may also be used in the present modification. In such a case, if an operation performed by the viewing user to transmit the information indicating interest in a person with regard to a viewed item (or transmitting operation) is accepted, the evaluation-value determining unit 105 determines an evaluation value by using the viewing history preceding the transmitting operation being performed. As a result, if the transmitting operation is accepted, the level-of-interest evaluator 106 also evaluates a degree of interest by using the viewing history preceding the transmitting operation being performed.

As described above, performing the transmitting operation clearly indicates that the viewing user has become interested in the person because of the introduction information viewed before the transmitting operation. Thus, the viewing history preceding the transmitting operation being performed indicates the degree of interest from the viewing user more clearly than the viewing history following the transmitting operation. In the present modification, the degree of interest from the viewing user is also evaluated more accurately than in the case where the degree of interest is evaluated by using the viewing history following the transmitting operation.

### 2-3 Automatic Selection of Emphasized Items

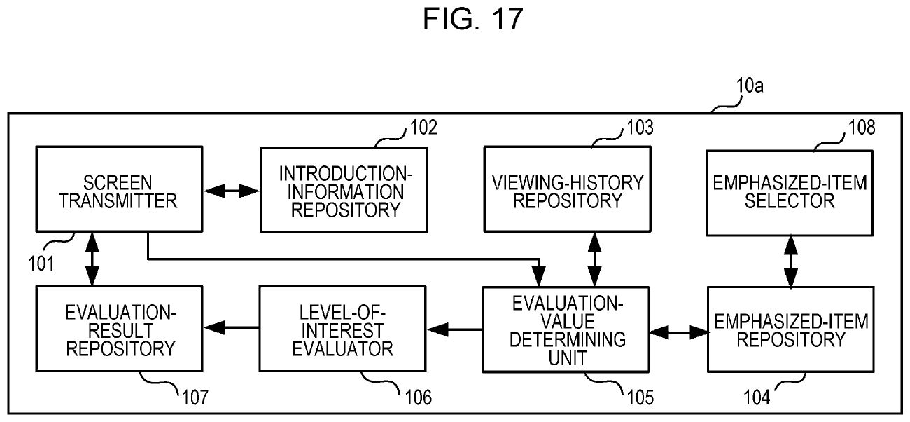

Although emphasized items are selected by an evaluating user or a viewing user in the exemplary embodiment and in the modifications above, emphasized items may be automatically selected. FIG. 17 depicts a functional configuration realized in the present modification. In the example in FIG. 17, an information processing apparatus 10a including an emphasized-item selector 108 in addition to each unit depicted in FIG. 4 is depicted.

The emphasized-item selector 108 selects from a plurality of items an item whose introduction content satisfies a predetermined selection condition. If the plurality of items each have one or more character strings that have been entered, the emphasized-item selector 108 determines based on a result of an analysis of the one or more character strings whether the selection condition is satisfied. For example, the emphasized-item selector 108 stores keywords used to determine whether the selection condition is satisfied and selects as an emphasized item an item whose analyzed character strings include at least one of the keywords.

Examples of a keyword include “emphasize”, “valuable”, and “relevant”, and words indicating that the user places emphasis on the item are used as a keyword. The emphasized-item selector 108 may weight each item in accordance with the number of keywords included in the item (the weight increasing with the number of keywords). The emphasized-item selector 108 provides the emphasized-item repository 104 with the selected emphasized items.

If one or more items are selected as the emphasized items from a plurality of items, the evaluation-value determining unit 105 thereafter acquires at minimum a viewing history associated with the one or more items selected as the emphasized items from the plurality of items and determines an evaluation value according to a procedure similar to the procedure in the exemplary embodiment. In this way, less time and effort of the user is required than in the case where no function of selecting emphasized items is available. Further, since whether the selection condition is satisfied is determined based on character strings, a user who has a larger amount of text to introduce the user is more likely to find a person who interests the user than in the case where the determination is not based on character strings.

### 2-4 Query on Selection

If emphasized items are automatically selected as described above, a query on whether to accept the selection may be sent to the user. In such a case, if an item out of a plurality of items has introduction content that satisfies the selection condition, the emphasized-item selector 108 provides the screen transmitter 101 with the item whose introduction content satisfies the selection condition.

The screen transmitter 101 creates a query screen for questioning whether to select the provided item as an emphasized item and transmits to the user terminal 20 the screen data representing the created query screen. The screen transmitter 101 transmits the screen data and thereby causes the user terminal 20 to present the query screen. The user terminal 20 to which the screen data is transmitted may be the terminal used by the evaluating user or a terminal used by a viewing user.

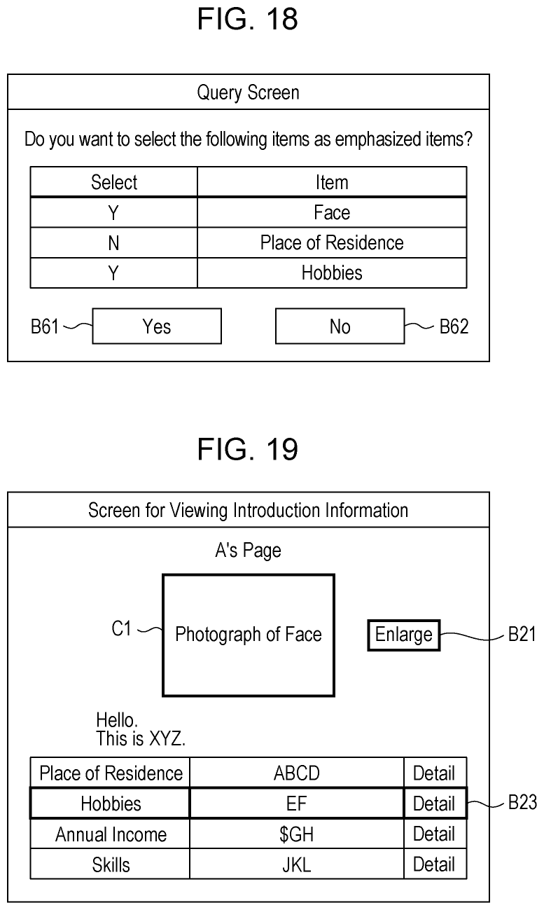

FIG. 18 depicts an example of the presented query screen. In the example in FIG. 18, the screen display 201 presents the character string “Do you want to select the following items as emphasized items?”, a list of items that are candidates for selection, a “Yes” button B61, and a “No” button B62. The list of items that are candidates for selection includes an entry column to receive “Y” or “N” indicating whether each item is selected. In response to an operation of pressing the “Yes” button B61, the screen display 201 transmits the data indicating the items “Face” and “Hobbies”, which are associated with “Y”, to the information processing apparatus 10 as the emphasized-item data.

According to the present modification, as described above, questioning whether to select an automatically selected item as an emphasized item avoids a risk that an item that the user does not intend to select is selected as an emphasized item.

### 2-5 Presentation of Introduction Information

The screen transmitter 101 may cause a screen to be presented in a manner that differs from the manner in the exemplary embodiment. For example, when causing the user terminal 20 of a viewing user to present the introduction information regarding an evaluating user, the screen transmitter 101 may cause a plurality of items to be presented in a mode in accordance with evaluated degrees of interest in the evaluating user.

FIG. 19 depicts an example of a presented screen for viewing introduction information. In the example in FIG. 19, it is assumed that the items “Face” and “Hobbies” are selected as emphasized items as depicted in FIG. 18. In this case, the screen display 201 presents the screen for viewing introduction information regarding the user A depicted in FIG. 7 so that the photograph of the face Cl and the enlarge button B21, which introduce the item “Face”, and the detail button B23, which introduces the item “Hobbies”, are all enclosed with thick lines.

Changing the presentation mode in this way enables the user to recognize the items emphasized by the evaluating user. When causing the user terminal 20 of a viewing user to present the introduction information regarding the evaluating user, the screen transmitter 101 may cause a plurality of items to be presented in the order according to evaluated degrees of interest in the evaluating user.

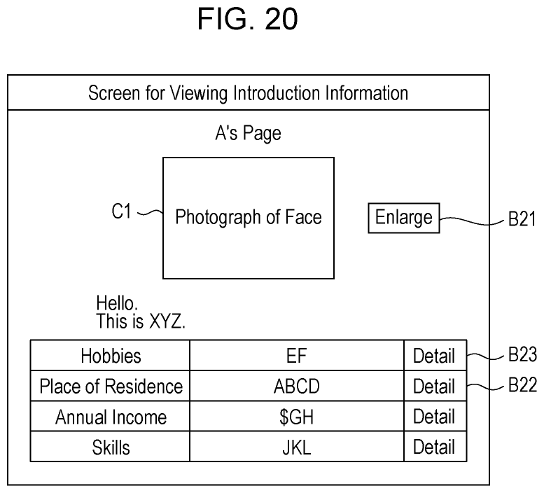

FIG. 20 depicts another example of a presented screen for viewing introduction information. In the example in FIG. 20, it is also assumed that the items “Face” and “Hobbies” are selected as emphasized items as depicted in FIG. 18. In this case, the screen display 201 presents the screen for viewing introduction information regarding the user A depicted in FIG. 7 so that the detail button B23, which introduces the item “Hobbies” selected as an emphasized item, is placed above the detail buttons introducing other information, such as the item “Place of Residence”, which is not selected as an emphasized item.

Since the photograph of the face C1 and the enlarge button B21 introducing the item “Face”, which is selected as an emphasized item, are presented at the top from the beginning, the screen display 201 presents these components at the original positions. Exchanging the presentation order in this way enables the user to recognize the items emphasized by the evaluating user.

### 2-6 Functional Configuration

A functional configuration realized by the matchmaking support system 1 is not limited to the configuration depicted in FIG. 4 and other Figures. For example, although the screen transmitter 101 of the information processing apparatus 10 creates matchmaking screens and transmits image data in the exemplary embodiment, these operations may be performed by using separate functions.

Further, for example, the determination of an evaluation value performed by the evaluation-value determining unit 105 and the evaluation of a level of interest performed by the level-of-interest evaluator 106 may be performed by using a single function. In addition, the functions realized by the information processing apparatus 10 may be realized by using a computer resource provided by more than two information processing apparatuses or in a cloud service. In other words, the range of operation performed by using each function and an apparatus to realize each function may freely be determined as long as the functions depicted in FIG. 4 and other Figures are realized in an image processing system as a whole.

### 2-7 Processor

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### 2-8 Categories of Disclosure

The present disclosure is to be understood not only as an information processing apparatus including devices such as user terminals but also an information processing system including information processing apparatuses (the matchmaking support system 1 is an example). The present disclosure is also to be understood as an information processing method to realize processes performed by using the information processing apparatuses or as a program to cause a computer to function to control the information processing apparatuses. The program may be provided in the form of a recording medium such as an optical disc storing the program. Alternatively, the program may be provided in the form of being downloaded onto a computer via a communication line such as the Internet, installed into the computer, and made available.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
acquire at minimum a viewing history associated with one or more items selected from a plurality of items for introducing a first user, and
determine an evaluation value for the first user in accordance with the acquired viewing history.

2. The information processing apparatus according to claim 1,
wherein the processor is configured to evaluate a degree of interest in the first user from a second user in accordance with the evaluation value.

3. The information processing apparatus according to claim 2,
wherein the first user selects the one or more items and the processor is configured to acquire the viewing history of the second user and evaluate the degree of interest in the first user from the second user.

4. The information processing apparatus according to claim 2,
wherein, in a case where a degree of emphasis is assigned to each of the plurality of items, the processor is configured to evaluate the degree of interest in accordance with the degree of emphasis assigned to each of the one or more items that have been viewed.

5. The information processing apparatus according to claim 3,
wherein, in a case where a degree of emphasis is assigned to each of the plurality of items, the processor is configured to evaluate the degree of interest in accordance with the degree of emphasis assigned to each of the one or more items that have been viewed.

6. The information processing apparatus according to claim 4,
wherein, in a case where an operation performed by the second user to transmit information indicating interest in the first user with regard to a viewed item is accepted, the processor is configured to evaluate the degree of interest by using a viewing history preceding acceptance of the operation.

7. The information processing apparatus according to claim 5,
wherein, in a case where an operation performed by the second user to transmit information indicating interest in the first user with regard to a viewed item is accepted, the processor is configured to evaluate the degree of interest by using a viewing history preceding acceptance of the operation.

8. The information processing apparatus according to claim 2,
wherein the second user selects the one or more items and the processor is configured to acquire the viewing history of the second user and evaluate the degree of interest in the first user from the second user.

9. The information processing apparatus according to claim 8,
wherein, in a case where a degree of emphasis is assigned to each of the plurality of items, the processor is configured to evaluate the degree of interest in accordance with the degree of emphasis assigned to each of the one or more items that have been viewed.

10. The information processing apparatus according to claim 9,
wherein, in a case where an operation performed by the second user to transmit information indicating interest in the first user with regard to a viewed item is accepted, the processor is configured to evaluate the degree of interest by using a viewing history preceding acceptance of the operation.

11. The information processing apparatus according to claim 1,
wherein the processor is configured to select from the plurality of items an item whose introduction content satisfies a predetermined selection condition.

12. The information processing apparatus according to claim 11,
wherein, in a case where one of the plurality of items includes one or more character strings that have been entered, the processor is configured to determine whether the selection condition is satisfied for the one of the plurality of items in accordance with a result of an analysis of the one or more character strings.

13. The information processing apparatus according to claim 12,
wherein, in a case where the plurality of items include an item whose introduction content satisfies the selection condition, the processor is configured to cause a screen to be presented, the screen being used to question whether to select the item whose introduction content satisfies the selection condition.

14. The information processing apparatus according to claim 1,
wherein the processor is configured to cause the plurality of items to be presented in an order or a mode according to an evaluated degree of interest in the first user.

15. The information processing apparatus according to claim 2,
wherein the processor is configured to cause the plurality of items to be presented in an order or a mode according to the evaluated degree of interest in the first user.

16. The information processing apparatus according to claim 3,
wherein the processor is configured to cause the plurality of items to be presented in an order or a mode according to the evaluated degree of interest in the first user.

17. The information processing apparatus according to claim 4,
wherein the processor is configured to cause the plurality of items to be presented in an order or a mode according to the evaluated degree of interest in the first user.

18. The information processing apparatus according to claim 5,
wherein the processor is configured to cause the plurality of items to be presented in an order or a mode according to the evaluated degree of interest in the first user.

19. The information processing apparatus according to claim 6,
wherein the processor is configured to cause the plurality of items to be presented in an order or a mode according to the evaluated degree of interest in the first user.

20. The information processing apparatus according to claim 7,
wherein the processor is configured to cause the plurality of items to be presented in an order or a mode according to the evaluated degree of interest in the first user.
